(19) United States
(12) Patent Application Publication
(10) Pub. No.: US 2007/0036446 A1
(43) Pub. Date: Feb. 15, 2007

(54) Apparatus and method of optimizing scan speed

(75) Inventor: Jie-hwan Park, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/485,503

(22) Filed: Jul. 13, 2006

(30) Foreign Application Priority Data
Aug. 9, 2005 (KR) 2005-72838

(51) Int. Cl. G06K 9/36

(52) U.S. Cl. 382/239

(57) ABSTRACT

An apparatus and method to optimize a scan speed, wherein a presence/absence of compression of a correspondent document is automatically determined and then scanned depending on a system performance such that documents can rapidly be scanned.

### CROSS-REFERENCE TO RELATED APPLICATIONS

This application claims the benefit under 35 U.S.C. § 119(a) of Korean Patent Application No. 2005-72838, filed on Aug. 9, 2005, in the Korean Intellectual Property Office, the entire contents of which are hereby incorporated by reference.

### BACKGROUND OF THE INVENTION 1. Field of the Invention

The present general inventive concept relates to an image forming apparatus, and more particularly, to a method capable of improving an image processing speed in accordance with a user environment and/or one or more system parameters.

2. Description of the Related Art

In general, image forming devices, such as scanners, printers, or multifunctional machines having both scanning and copying functions, are connected to a host computer in order to operate.

When an image is scanned, the host computer (hereinafter, referred to as “host device”) generates scan information based on a set resolution, a presence/absence of data, and the like, and then transmits the scan information to an image forming apparatus. In this case, the image forming apparatus scans a corresponding document based on the set resolution, the presence/absence of data, and the like. The scan information is compressed or decompressed for image processing, then the image processed scan information (i.e., data) is transmitted out of the image forming apparatus in the state of being compressed or decompressed again. That is, the image processed data is transmitted in a BMP (bitmap) or JPEG (Joint Picture Expert Group) file format to the host device that has requested an operation.

When using the BMP file format for the image processed data, a file size has a tendency to be larger than necessary because picture data is inefficiently stored. On the other hand, when using the JPEG file format, although a data quantity is small (smaller than BMP), there is a need for post-processing for compressing or decompressing the data.

Accordingly, if the image forming apparatus supports both the JPEG and BMP file formats, the JPEG file format is used for the image processing. Alternatively, if the image forming apparatus supports only the BMP file format, the BMP file format is used.

FIG. 1 illustrates a conventional method of performing a scanning operation depending on a file format supported by an image forming apparatus.

If a scan instruction is input to a host device (operation S10), the host device identifies through a scanner driver whether the image forming apparatus supports a file format (operation S20). That is, the host device inquires as to whether the image forming apparatus supports the JPEG file format.

The image forming apparatus then informs the scanner driver of the host device as to whether the JPEG file format is supported (operation S30).

If the JPEG file format is supported (operation S40), the host device requests scan data transmission in the JPEG file format (operation S42). Accordingly, the image forming apparatus generates the scan data in the JPEG file format, then transmits the scan data to the host device (operation S44).

The host device performs a decoding operation on the transmitted JPEG scan data to convert the JPEG scan data to a BMP file format (operation S46), and then stores the BMP file in a memory or in a file format (operation S60).

In the operation S40, if the JPEG file format is not supported (in the case that a compressed format is not supported), the host device requests the scan data transmission in an uncompressed format (i.e., the BMP file format) (operation S50). Accordingly, the image forming apparatus transmits the scan data in the BMP file format (operation S52).

Then, the host device stores the transmitted BMP file in the memory or in the file format (operation S60).

As described above, if the image forming apparatus supports the JPEG file format, the host device performs the scanning operation by requesting a JPEG scan. However, if an operation ability of the host device is low, the reception of the JPEG scan data having less data quantity is fast, but a processing speed of the decoding operation to decode the JPEG scan data to the BMP file format is slow as a result of the low operation ability of the host device, thereby causing a reduction of a scan speed. Thus, even though a transmission speed of the JPEG scan data is fast, the scan speed is limited by the processing speed of the JPEG data including the decoding operation.

In general, practical scan time contains time for compressing, transmitting, and decompressing an image. This is due to the fact that when JPEG files are used, the transmission speed of compressed data is fast, but decompression (i.e., the decoding operation) of the compressed data takes much more time than that of uncompressed data when the operation ability (i.e., performance) of the host device is low.

Accordingly, a method of improving a scan speed in accordance with a system environment is required.

### SUMMARY OF THE INVENTION

The present general inventive concept provides a method and an apparatus capable of scanning a scan image format automatically determining a presence/absence of compression of a correspondent document depending on a system performance.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a method of optimizing a scan speed of an image forming apparatus in communication with a host device to transmit a compressed image, the method including determining a performance of the host device, determining an image transmission format in a compression mode or a non-compression mode in accordance with the determined performance of the host device, and scanning and transmitting a document based on the determined image transmission format.

The determining of the performance of the host device is performed using a data storing speed, a decoding speed, and a data transmission speed with respect to communication with the image forming apparatus, and is represented by applying a first expression, as follows:
Fc+Fs≧Fd
where Fc represents the data transmission speed determined by whether USB 1.1 or USB 2.0 is connected between the host device and the image forming apparatus, Fs represents the data storing speed of the host device when storing data transmitted from the image forming apparatus, and Fd represents the decoding speed which is a time required to decode a compressed file received from the image forming apparatus.

The host device requests data in the compressed file if the first expression is satisfied, and the determining of the performance of the host device is represented by applying a second expression in a short form, as follows:
Fc≧Fd

The foregoing and/or other aspects of the present general inventive concept are also achieved by providing a method of optimizing a scan speed of an image forming apparatus in communication with a host device, the method including identifying whether or not the image forming apparatus supports a file format, determining a performance of the host device if it is determined that a compressed image is capable of being transmitted by the image forming apparatus, determining an image transmission format in a compression mode or a non-compression mode in accordance with the determined performance of the host device, and transmitting a document based on the determined image transmission format.

The foregoing and/or other aspects of the present general inventive concept are also achieved by providing a system to optimize a scan speed, including a host device to transmit an image transmission format for a document to be scanned, and an image apparatus in communication with the host device to scan the document based on the transmitted image transmission format, wherein the image transmission format is determined in accordance with a performance of the host device.

The host device requests the document to be scanned in a compression format if the first expression (described above) is satisfied, and determines the performance of the host device if it is determined that the image forming apparatus can support the compression format.

The foregoing and/or other aspects of the present general inventive concept are also achieved by providing a method of improving a scan speed in an image forming system, the method including determining whether a transmission speed of data between an image forming apparatus and a host device is greater than or equal to a decoding speed of compressed data by the host device, and instructing the image forming apparatus to provide uncompressed scan data to the host device when the transmission speed between the image forming apparatus and the host device is greater than or equal to the decoding speed of compressed data by the host device.

The foregoing and/or other aspects of the present general inventive concept are also achieved by providing an image forming system, including an image forming apparatus having a scan unit to scan a document in one or more predetermined data formats, and a host device in communication with the image forming apparatus to select one of the predetermined data formats based on supportability of the one or more predetermined data formats and one or more performance parameters of the system, and to instruct the image forming apparatus to provide scan data from the scanned document using the selected data format.

The foregoing and/or other aspects of the present general inventive concept are also achieved by providing an image forming system, including a scanning unit to scan an image and to output scan data of the scanned image in either a compressed format or an uncompressed format, and a host device to compare processing times of the scan data to be output by the scanning unit in both the compressed format and the uncompressed format and to select the one of the compressed and uncompressed format having the shorter processing time for the image forming system to use.

The foregoing and/or other aspects of the present general inventive concept are also achieved by providing a host device to optimize a scan speed of an image forming system having an image forming apparatus in communication with the host device, the device including a controller to operate in a first scan mode using a compressed scan data format when one or more performance parameters of the host device indicate that the host device is high performance and the compressed scan data format is supported by the image forming apparatus, and to operate in a second scan mode using an uncompressed scan data format when the one or more performance parameters of the host device indicate that the host device is not high performance or when the compressed scan data format is not supported by the image forming apparatus.

The foregoing and/or other aspects of the present general inventive concept are also achieved by providing a computer readable medium containing executable code to perform a method of improving a scan speed in an image forming system, the method including determining whether a transmission speed of data between an image forming apparatus and a host device is greater than or equal to a decoding speed of compressed data by the host device, and instructing the image forming apparatus to provide uncompressed scan data to the host device when the transmission speed between the image forming apparatus and the host device is greater than or equal to the decoding speed of compressed data by the host device.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a flowchart illustrating a conventional method of performing a scanning operation depending on a format supported by an image forming apparatus;

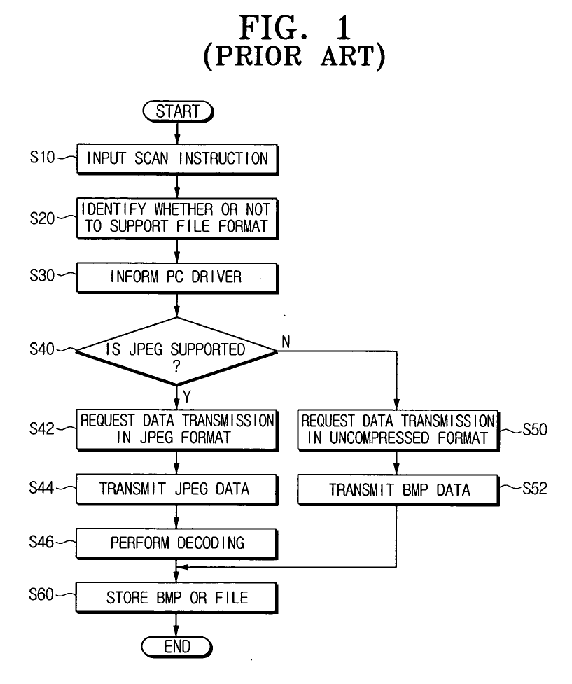

FIG. 2 is a view schematically illustrating an image forming apparatus controlled by a host device according to an embodiment of the present general inventive concept;

FIG. 3 is a flowchart illustrating a method of determining a compression mode for each format depending on a performance of a host device according to an embodiment of the present general inventive concept;

FIG. 4 is a graphic chart illustrating time consumed when performing a PC-scan in a BMP format according to an embodiment of the present general inventive concept; and

FIG. 5 is a graph illustrating time consumed when performing a PC-scan in a JPEG format according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

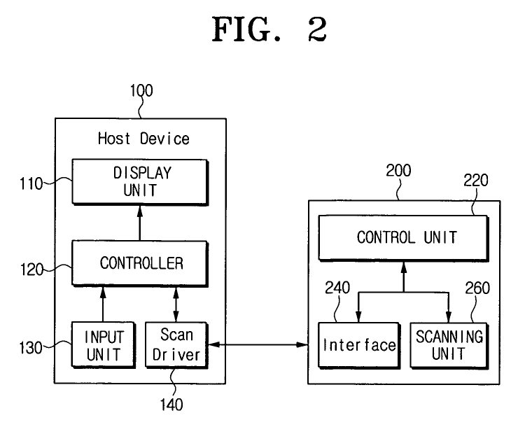

FIG. 2 is a view schematically illustrating an image forming apparatus 200 controlled by a host device 100 according to an embodiment of the present general inventive concept.

The host device 100 controls a scanning operation using the image forming apparatus 200 such as a scanner or a multifunctional machine having a scanning function, and includes a display unit 110, a controller 120, an input unit 130, and a scan driver 140 so as to receive scanned data from the image forming apparatus 200.

The input unit 130 may include, for example, a keyboard or mouse (not shown), and the display unit 110 is provided to display a UI (User Interface) capable of setting an operation state of a system and the scan driver 140.

The controller 120 controls overall operations of the host device 100 and displays resolution of data, which is scanned by loading the scan driver 140, to be set through the display unit 110 if a scan mode is selected through the input unit 130. The controller 120 may determine a performance of the host device 100 including one or more of a communication speed with the image forming apparatus 200, a storing speed of data transmitted from the image forming apparatus 200, a decoding speed of data transmitted in a JPEG format from the image forming apparatus 200, and/or the like. Accordingly, the controller 120 requests the image forming apparatus 200 to output the scanned data in any one of a BMP format (uncompressed) and a JPEG format (compressed). Other compressed and uncompressed formats may also be used.

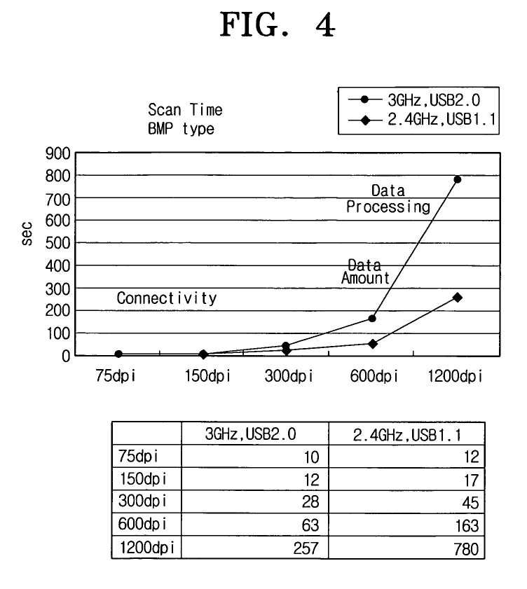

A scanning time in accordance with a BMP file format will now be described with reference to FIG. 4.

FIG. 4 is a graphic chart illustrating time consumed when performing a PC-scan in the BMP format depending on the performance of the host device. The Y-axis represents time required and the X-axis represents image resolution in dots-per-inch (dpi). The image resolution in dpi relates to a data quantity. Further, performance evaluation elements of a CPU are also illustrated in FIG. 4. As illustrated therein, when the performance of the host device 100 is slow, the time required is gradually increased as the dpi is increased.

Also, since data quantity to be processed is a small quantity when the dpi is low, a connectivity speed (USB/LPT) is an essential element that affects a scan speed. Although the connectivity speed remains constant as the dpi is increased, a great difference in data processing speed is produced. Here, since the scanned data is transmitted in the BMP format, an overall data processing speed due to the performance of the host device 100 is considerably decreased as the data quantity is increased.

Referring to FIG. 4, the scan speed is influenced by two factors including a CPU operation speed and the connectivity speed. When using one of USB 2.0 and USB 1.1 (i.e., transmission specifications) as a connection between the host device 100 and the image forming apparatus 200, which have the same performance regardless of the image resolution in dpi, the data processing speed (Time Complexity, 0(n)) shows a linear increase for the dpi. However, in the graph of FIG. 4, a difference in the scan speeds is not simply linear as the dpi is increased. In particular, a nonlinear element of the CPU operation speed (Time and Space Complexity) is added. That is, since the connectivity speeds are the same regardless of the data quantity when a low dpi is used, a performance comparison is possible, and the scan speed is influenced by the data processing speed, which corresponds to the CPU operation speed indicating a performance thereof, as the dpi is increased.

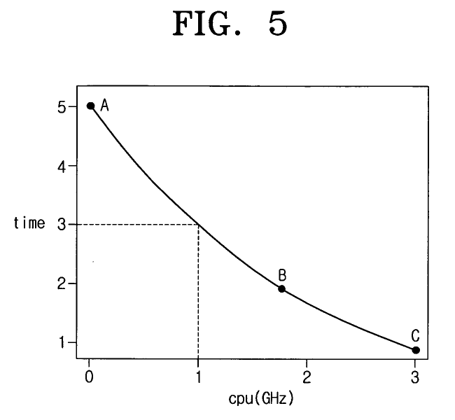

Further, a scanning time in accordance with a JPEG file format will now be described with reference to FIG. 5.

FIG. 5 is a graph illustrating an experimental value measuring decoding times depending on a performance of a CPU (i.e., the CPU operation speed in GHz).

Referring to FIG. 5, the X-axis represents the performance of the CPU, and the Y-axis represents a decoding process time having a reference of 150 dpi. In FIG. 5, “A” refers to a decoding process time that takes approximately 5 seconds when a 0.2 GHz CPU is used, and “B” refers to a decoding process time that takes approximately 2 seconds when a 1.8 GHz CPU is used. Also, “C” refers to a decoding process time that takes approximately 1 second when a 3.0 GHz CPU is used. That is, if the CPU has a performance of 1 GHz, an expected time of the decoding process at 150 dpi is approximately 3 seconds.

Further, when a 150 dpi image of 26 Mbytes is processed, a transmission speed (Fc ) for each USB class is measured as illustrated in the following TABLE 1.

TABLE 1

| | Minimum Required Time | Maximum required time |
|---|---|---|
| USB Class | (Max BW) | (Min BW) |
| USB 1.1 | 19 sec | 173 sec |
| USB 2.0 | 0.5 sec | 4.3 sec |

In the TABLE 1, since a bandwidth is 10 to 90% when a bulk mode is used, a minimum required time indicates a transmission time when a maximum bandwidth is used, and a maximum required time indicates a transmission time when a minimum bandwidth is used. Here, the bandwidth refers to a transmission band allocated with respect to the bulk mode needed for data transmission in accordance with characteristics of a USB. In general, when there are a plurality of USB devices to be connected, the bandwidth is decreased. On the other hand, when there is no other USB device to be connected, the bandwidth is increased. That is, in USB specifications, the bandwidth can be guaranteed down to a minimum 10% and up to a maximum 90%.

Accordingly, referring to FIGS. 4 and 5, and TABLE 1, if a 1 GHz CPU has a broad bandwidth (i.e., Max BW) for the 150 dpi image and USB 2.0 is used, although the JPEG format is supported, the decoding process time for the JPEG format takes approximately 3 seconds. However, the transmission time required when the scanned data is transmitted in the BMP format takes 0.5 second such that the scan speed can be increased by using the BMP format. Further, if the bandwidth is narrow (i.e., the minimum bandwidth) in the same condition, the transmission time required when the data is processed in the BMP format takes 4.3 seconds such that the scan speed can be increased in the JPEG format. Thus, since the transmission time plus the decoding process time at the maximum bandwidth (3.5 seconds) is less when using the JPEG format than the transmission time (4.3 seconds) when using the BMP format, the JPEG format can be selected to increase the scan speed when using the 1 GHz CPU with the USB 2.0 for the 150 dpi image.

The following TABLE 2 illustrates a comparison of performances when using the BMP and JPEG formats with reference to FIGS. 4 and 5.

TABLE 2

| | Transmission | | |
|---|---|---|---|
| Format | Speed (Fc) | Storing Speed (Fs) | Decoding speed (Fd) |
| BMP | Slow | Slow | Not needed |
| JPEG | Fast | Fast | Needed |

Referring to TABLE 2, as a system performance (i.e., a decoding speed in accordance the performance of the CPU) is increased, it is desirable to scan the data in the JPEG format. Thus, if the following EXPRESSION 1 is satisfied with an equality identifying the system performance, the controller 120 requests the image forming apparatus 200 to transmit the scanned data in the JPEG format. Otherwise, the controller 120 requests the image forming apparatus 200 to transmit the scanned data in the BMP format.
Fc+Fs≧Fd EXPRESSION 1
where “Fc” represents a transmission speed determined by whether the USB 1.1 or the USB 2.0 is connected between the host device 100 and the image forming apparatus 200, and “Fs” represents a data storing speed of the host device 100 when storing the scanned data transmitted from the image forming apparatus 200. “Fd” represents the decoding speed at which a JPEG file transmitted from the image forming apparatus 200 is decoded by the host device 100.

Further, since the storing speeds (Fs) of a BMP format file and an uncompressed JPEG format file are almost equal to each other in the same host device 100, the EXPRESSION 1 can be approximated as EXPRESSION 2, as follows, when using the same host device 100:
Fc≧Fd EXPRESSION 2

As illustrated in FIG. 2, the image forming apparatus 200 includes a control unit 220, an interface 240, and a scanning unit 260.

The control unit 220 controls overall operations of the image forming apparatus 200 in accordance with a control program, which may be stored in an internal ROM.

The interface 240 may be connectable (wirelessly or with a wire) with the host device 100, and supports a communication interface with the host device 100. That is, the interface 240 receives printing data transmitted from the host device 100 and transmits the scanned data scanned by the scanning unit 260 to the host device 100.

Further, the scanning unit 260 reads image data by scanning a scanning object document depending on scan information transmitted in accordance with a control of the controller 120 of the host device 100, such as an image resolution and a presence/absence of data compression, etc. The image forming apparatus 200 then transmits the scanned data that corresponds to the read image data to the host device 100 via the interface 240.

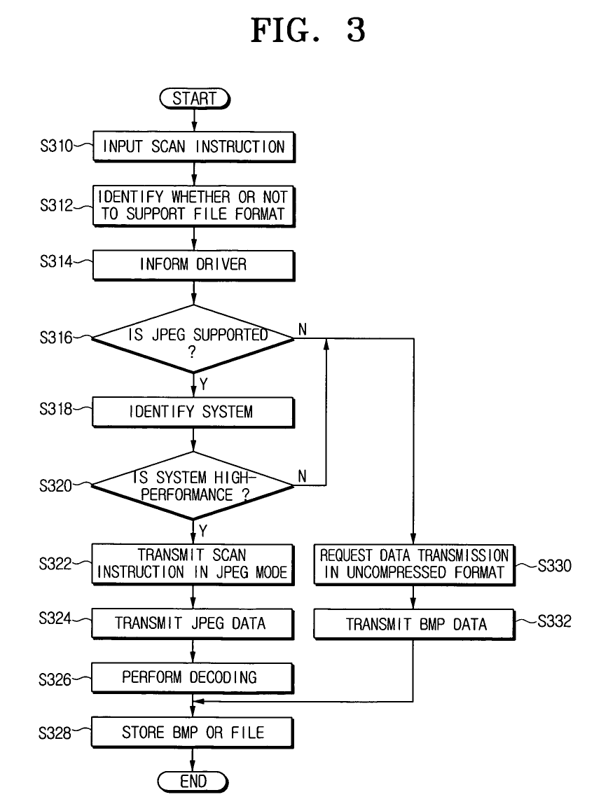

FIG. 3 illustrates a method of optimizing a scan speed according to an embodiment of the present general inventive concept. The method of optimizing the scan speed may be performed by the image forming apparatus 200 and/or the host device 100 of FIG. 2. Accordingly, for illustration purposes, the method of optimizing the scan speed is described below with reference to FIG. 2.

Referring to FIG. 3, if a scan instruction is input from a UI displayed on the display unit 110 through the input unit 130 (operation S310), the controller 120 requests a supportable file format from the image forming apparatus 200 (operation S312). That is, in the operation S312, the controller 120 inquires as to whether the JPEG format is supported in the image forming apparatus 200.

The control unit 220 then receives the request (i.e., the inquiry) through the interface 240 and informs the scan driver 140 of the host device 100 of the supportable file format (i.e., whether the JPEG format is supported) (operation S314).

When the control unit 220 determines whether to support the JPEG format in the operation S314, the control unit 220 notifies the controller 120 (operation S316). If the JPEG format is determined not to be supported, the controller 120 requests the image forming apparatus 200 to transmit the scanned data of a document in an uncompressed file (i.e., the BMP format) (operation S330). Then, the control unit 220 of the image forming apparatus 200 drives the scanning unit 260 to scan the document and transmit the scanned data as BMP data to the host device 100 (operation S332).

If the image forming apparatus 200 is determined to support the JPEG format in the operation S316, the controller 120 identifies the system performance (i.e., the performance of the host device 100) (operation S318).

At this time, a performance evaluation method is used to compare and determine the transmission speed (Fc), the storing speed (Fs), and the decoding speed (Fd) of the system including the host device 100 and the image forming apparatus 200 using the EXPRESSION 1 (described above).

Alternatively, the transmission speed (Fc) and the decoding speed (Fd) can simply be compared and determined using the EXPRESSION 2.

Therefore, if the transmission speed (Fc) is determined to be less than the decoding speed (Fd) in the operation S320, it is determined that the system performance is excellent (i.e., high performance), and the controller 120 of the host device 100 requests that the image forming apparatus 200 transmit the scanned data in the JPEG format (operation S322).

The controller 120 may pre-store each combination of system parameters to correspond to a plurality of transmission speeds (Fc), a plurality of decoding speeds (Fd), and a plurality of storing speeds (Fs). For example, the system parameters may include the USB transmission specification, the CPU operation speed, the connectivity speed, bandwidth, data amount, the image resolution (in dpi), etc. Accordingly, the controller 120 can determine the performance of the host device 100 in the operation S320, and the system more generally, by accessing the pre-stored combination of system parameters and corresponding performance speeds. The pre-stored system parameters and corresponding performance speeds are described above with respect to TABLES 1 and 2, and FIGS. 4 and 5.

Then, if the image forming apparatus 200 transmits the scanned data in the JPEG format to the host device 100 (operation S324), the host device 100 decodes the transmitted data and then compresses or decompresses (operation S326).

If it is determined that the transmission speed (Fc) is faster than the decoding speed (Fd) in the operation S320, the system is determined not to have high performance and the scanned data is processed in the same manner as when the image forming apparatus 200 does not support the JPEG format. That is, the controller 120 requests that the image forming apparatus 200 scan the document in the BMP format and transmit the scanned data (the operation S330), and the control unit 220 of the image forming apparatus 200 drives the scanning unit 260 to scan the document and transmit the scanned data in the BMP format to the host device 100 (operation S332).

As described above, a BMP file having the scanned data which is compressed or decompressed in the host device 100, or which is directly transmitted from the image forming apparatus 200 is image processed. The image-processed data is then compressed again to be stored or transmitted as a current (uncompressed) image to one or more applications (operation S328).

The present general inventive concept may be embodied as executable code in computer readable media including storage media such as magnetic storage media (ROMs, RAMs, floppy disks, magnetic tapes, etc.), optically readable media (CD-ROMs, DVDs, etc.), and carrier waves (transmission over the Internet). For example, the computer readable media may contain a printer/scanner driver program.

In the light of foregoing, the various embodiments of the present general inventive concept can optimize a scan speed by analyzing peripheral environment and system performance of an image apparatus and a host device connected thereto.

Also, an apparatus and a method of optimizing a scan speed, according to the various embodiments of the present general inventive concept, optimizes a format for image transmission to be suitable for a user's environment when performing a scan operation using a PC environment, thereby enhancing an image processing speed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of optimizing a scan speed of an image forming apparatus in communication with a host device to transmit a compressed image, the method comprising:
determining a performance of the host device;
determining an image transmission format in a compression mode or a non-compression mode in accordance with the determined performance of the host device; and
scanning and transmitting a document based on the determined image transmission format.

2. The method according to claim 1, wherein the determining of the performance of the host device is performed using a data storing speed, a decoding speed, and a data transmission speed with respect to communication with the image forming apparatus.

3. The method according to claim 2, wherein the determining of the performance of the host device comprises applying a first expression, as follows:
Fc+Fs≧Fd
where Fc represents the data transmission speed determined by whether USB 1.1 or USB 2.0 is connected between the host device and the image forming apparatus, Fs represents the data storing speed of the host device when storing data associated with the scanned document transmitted from the image forming apparatus, and Fd represents the decoding speed which is a time required to decode a compressed file received by the host device from the image forming apparatus.

4. The method according to claim 3, wherein the host device requests data in the compressed file if the first expression is satisfied.

5. The method according to claim 2, wherein the determining of the performance of the host device comprises applying a second expression, as follows:
Fc≧Fd
where Fc represents the data transmission speed determined by whether USB 1.1 or USB 2.0 is connected between the host device and the image forming apparatus, and Fd represents the decoding speed which is a time required to decode a compressed file received by the host device from the image forming apparatus.

6. A method of optimizing a scan speed of an image forming apparatus in communication a host device, the method comprising:
determining whether the image forming apparatus supports a compressed file format;
determining a performance of the host device, if the compressed file format is determined to be supported by the image forming apparatus;
determining an image transmission format as a compression mode or a non-compression mode in accordance with the determined performance of the host device; and
transmitting a document based on the determined image transmission format.

7. The method according to claim 6, wherein the determining of the performance of the host device is performed using a data storing speed, a decoding speed, and a data transmission speed with respect to communication with the image forming apparatus.

8. The method according to claim 7, wherein the inspecting of the performance of the host device comprises applying a first expression, as follows:
Fc+Fs≧Fd
where Fc represents the data transmission speed determined by whether USB 1.1 or USB 2.0 is connected between the host device and the image forming apparatus, Fs represents the data storing speed of the host device when storing data associated with the document transmitted from the image forming apparatus, and Fd represents the decoding speed which is a time required to decode a compressed file received from the image forming apparatus.

9. The method according to claim 8, wherein the host device requests data in the compressed file format if the first expression is satisfied.

10. The method according to claim 7, wherein the determining of the performance of the host device comprises applying a second expression, as follows:
Fc≧Fd
where Fc represents the data transmission speed determined by whether USB 1.1 or USB 2.0 is connected between the host device and the image forming apparatus, and Fd represents the decoding speed which is a time required to decode a compressed file received from the image forming apparatus.

11. A method of improving a scan speed in an image forming system, the method comprising:
determining whether a transmission speed of data between an image forming apparatus and a host device is greater than or equal to a decoding speed of compressed data by the host device; and
instructing the image forming apparatus to provide uncompressed scan data to the host device when the transmission speed between the image forming apparatus and the host device is greater than or equal to the decoding speed of compressed data by the host device.

12. The method according to claim 11, further comprising:
storing a plurality of decoding speeds to correspond to different system parameters and a plurality of transmission speeds to correspond to the different system parameters.

13. The method according to claim 12, wherein the determining of whether the transmission speed of data between the image forming apparatus and the host device is greater than or equal to the decoding speed of compressed data by the host device comprises:
determining one or more current system parameters of the image forming system; and
accessing the stored plurality of decoding speeds and transmission speeds to determine a stored decoding speed and a stored transmission speed that correspond to the one or more current system parameters as the transmission speed of data between the image forming apparatus and the host device and the decoding speed of compressed data by the host device, respectively.

14. The method according to claim 12, wherein the different system parameters comprise one or more of a USB transmission specification, a CPU operation speed, a connectivity speed, a bandwidth, a data amount, and an image resolution.

15. The method according to claim 11, further comprising:
instructing the image forming apparatus to provide compressed scan data to the host device when the transmission speed of data between the image forming apparatus and the host device is less than the decoding speed of compressed data by the host device.

16. An image forming system to optimize a scan speed, comprising:
a host device to transmit an image transmission format for a document to be scanned; and
an image forming apparatus in communication with the host device to scan the document based on the transmitted image transmission format,
wherein the image transmission format is determined in accordance with a performance of the host device.

17. The system according to claim 16, wherein the performance of the host device is determined using a data storing speed, a decoding speed, and a data transmission speed with respect to communication with the image forming apparatus.

18. The system according to claim 17, wherein the performance of the host device is determined by applying a first expression, as follows:
Fc+Fs≧Fd
where Fc represents the data transmission speed determined by whether USB 1.1 or USB 2.0 is connected between the host device and the image forming apparatus, Fs represents the data storing speed of the host device when storing data associated with the scanned document transmitted from the image forming apparatus, and Fd represents the decoding speed which is a time required to decode a compressed file received from the image forming apparatus.

19. The system according to claim 18, wherein the host device requests the document to be scanned in a compression format if the first expression is satisfied.

20. The system according to claim 16, wherein the host device determines the performance thereof if it is determined that the image forming apparatus supports a compression format.

21. The system according to claim 17, wherein the performance of the host device is determined by applying a second expression, as follows:
Fc≧Fd
where Fc represents the data transmission speed determined by whether USB 1.1 or USB 2.0 is connected between the host device and the image forming apparatus, and Fd represents the decoding speed which is a time required to decode a compressed file received from the image forming apparatus.

22. An image forming system, comprising:
an image forming apparatus having a scan unit to scan a document in one or more predetermined data formats; and
a host device in communication with the image forming apparatus to select one of the predetermined data formats based on supportability of the one or more predetermined data formats and one or more performance parameters of the system, and to instruct the image forming apparatus to provide scan data from the scanned document using the selected data format.

23. An image forming system, comprising:
a scanning unit to scan an image and to output scan data of the scanned image in either a compressed format or an uncompressed format; and
a host device to compare processing times of the scan data to be output by the scanning unit in both the compressed format and the uncompressed format and to select the one of the compressed and uncompressed format having the shorter processing time for the image forming system to use.

24. The system according to claim 23, wherein the processing time of the compressed format comprises a corresponding transmission time of compressed data from the scanning unit to the host device plus a corresponding decoding time of the compressed data, and the processing time of the uncompressed format comprises a corresponding transmission time of uncompressed data.

25. The system according to claim 23, wherein the processing times depend on system performance parameters such that if the system has high performance, the processing time of the compressed format is shorter.

26. A host device to optimize a scan speed of an image forming system having an image forming apparatus in communication with the host device, the device comprising:
a controller to operate in a first scan mode using a compressed scan data format when one or more performance parameters of the host device indicate that the host device is high performance and the compressed scan data format is supported by the image forming apparatus, and to operate in a second scan mode using an uncompressed scan data format when the one or more performance parameters of the host device indicate that the host device is not high performance or when the compressed scan data format is not supported by the image forming apparatus.

27. The host device according to claim 26, wherein the compressed scan data format and the uncompressed scan data format comprise JPEG format and bitmap format, respectively.

28. The host device according to claim 26, wherein the controller transmits a first communication to the image forming apparatus to determine whether the image forming apparatus supports the compressed scan data format, receives a second communication from the image forming apparatus indicating whether the image forming apparatus supports the compressed scan data format, transmits a third communication to the image forming apparatus to instruct the image forming apparatus to request transmission of scan data in one of the compressed scan data format and the uncompressed scan data format according to whether the controller is operating the image forming system in the first or second scan mode, respectively, and receives a fourth communication including the scan data.

29. The host device according to claim 26, wherein the controller compares processing times of the compressed scan data format and the uncompressed scan data format and selects the one with the shorter processing time.

30. A computer readable medium containing executable code to perform a method of improving a scan speed in an image forming system, the method comprising:
determining whether a transmission speed of data between an image forming apparatus and a host device is greater than or equal to a decoding speed of compressed data by the host device;
instructing the image forming apparatus to provide uncompressed scan data to the host device when the transmission speed between the image forming apparatus and the host device is greater than or equal to the decoding speed of compressed data by the host device; and
instructing the image forming apparatus to provide compressed scan data to the host device when the transmission speed of data between the image forming apparatus and the host device is less than the decoding speed of compressed data by the host device.
